(19) United States
(12) Patent Application Publication
(10) Pub. No.: US 2003/0225892 A1
(43) Pub. Date: Dec. 4, 2003

(54) Handover method in mobile communication system and router device used in mobile communication system

(76) Inventors: Hideaki Takusagawa, Kawasaki (JP); Ryuichi Takechi, Kawasaki (JP); Keiichi Nakatsugawa, Kawasaki (JP); Takeshi Kawasaki, Kawasaki (JP); Kazuyuki Oka, Yokohama (JP)

Correspondence Address: KATTEN MUCHIN ZAVIS ROSENMAN, 575 MADISON AVENUE, NEW YORK, NY, 10022-2585, US

(21) Appl. No.: 10/373,538

(22) Filed: Feb. 25, 2003

(30) Foreign Application Priority Data
Jun. 4, 2002 (JP) 2002-162421

(51) Int. Cl. G06F 15/16

(52) U.S. Cl. 709/227

(57) ABSTRACT

An old care-of address is assigned to a mobile node in the communication area of the old access router and the mobile node is communicating with a correspondent node. Immediately before the mobile node enters the communication area of a new access router, a binding update message is transmitted to a diverging point router. The diverging point router is a router device located in the node where a route from the correspondent node to the old access router and a route from the correspondent router to the new access router are diverged. The diverging point router transfers packets addressed to the old care-of address to the new care-of address assigned to the mobile node in the communication area of the new access router.

### BACKGROUND OF THE INVENTION

1. Field of the Invention

The present invention relates to a handover method in a mobile communication system and a router device used in the mobile communication system, and in particular, it relates to a handover method in an IP network provided by mobile communication services and a router thereof.

2. Description of the Related Art

Recently, with the explosive spread of the Internet and cellular phones, a variety of systems for accessing the Internet have been developed. For example, second generation mobile communication networks, such as GPRS (general packet radio system), PDC-P (personal digital cellular-mobile packet communication system), etc., third generation mobile communication networks, such as UMTS (universal mobile telecommunication system), etc., small-scaled wireless access networks, such as the wireless LAN, Bluetooth, etc., and the like have been put into practical use. In the future, the development of fourth generation mobile communication network and other new access technologies is expected. In this way, thanks to these technologies, currently, one node can be connected to a plurality of access systems and the realization of a ubiquitous environment can be expected.

However, it is preferable for a user to be connected to the Internet without the awareness of an access system. In order to realize such an environment, a technology for a node autonomously selecting or switching an access system is needed. Attention is therefore paid to Mobile IP as the core technology to realize such an environment.

Mobile IP is standardized by the IETF (Internet Engineering Task Force). The Mobile IP standardized in the RFC2002 of IETF is based on IPv4 (RFC791). However, recently, there has been a shortage of IPv4 addresses as the number of nodes has increased on the IP network, and so the shift from IPv4 to IPv6 (RFC2460) has been promoted. Mobile Ipv6 based on Ipv6 is published as an Internet draft (http://www.ietf.org/internet-drafts/draft-ietf-mob ileip-ipv6-14.txt) and is scheduled to be standardized in the near future. The operation of Mobile Ipv6 is described below. However, the operation of Mobile Ipv6 is basically the same as that of Mobile IP.

In Mobile IPv6, generally, a home address and a care-of address (CoA) are assigned to each mobile node. In this case, the home address is fixedly assigned to each mobile node. The care-of address is assigned to each mobile node by each access router accommodating the mobile node. If the mobile node travels, the care-of address is dynamically assigned to the mobile node in accordance with the travel itinerary and the communication session is maintained.

However, generally, the handover of Mobile Ipv6 incurs much delay. This is because when a mobile node travels from the communication area of a certain access router (old access router) to the communication area of another access router (new access router), the mobile node acquires a new care-of address by exchanging messages between the mobile node and the new access router through a wireless link after the mobile node has traveled to the communication area of the new access router. In this case, usually, the delay of the handover is caused by the poor performance of radio process. Therefore, Mobile Ipv6 is not suitable for real-time applications in UDP (RFC768)/RTP (RFC1889), such as an Internet telephone, live streaming and the like or applications in TCP (RFC793) that are sensitive to delay.

As a technology for solving this problem, a fast handover procedure has been proposed. The fast handover procedure is published as an Internet draft (http://www.ietf.org/internet-drafts/draft-ietf-mob ileip-fast-mipv6-04.txt) by the IETF. In the fast handover procedure, the mobile node acquires a new care-of address to be used in the communication area of the new access router, immediately before the mobile node enters the communication area of a new access router from the communication area of an old access router. In this way, the time period during which no communication is possible at the time of handover can be reduced.

Next, the fast handover procedure is described. The fast handover procedure can be classified into the following two types: a method initiated by a network and a method initiated by a mobile node. The fast handover procedure can also be classified into the following two types: a method in which a network generates an address (stateful address auto-configuration: http://www.ietf.org/internet-drafts/draft-ietf-dhcdhcpv6-20.txt) and a method in which a mobile node generates an address (stateless address auto-configuration: RFC2462). Currently, the following three types of procedures are defined.

(1) Network-initiated, stateful

(2) Network-initiated, stateless

(3) Mobile node-initiated, stateless

Since the basic operations of these three methods are the same, the summary of method (1) is described below.

FIG. 1 shows the basic procedure of the fast handover process. FIG. 2 is a sequence chart showing the process outlined in FIG. 1. In this example, a mobile node (MN) 1 travels from the communication area of an old access router (AR) 2 to the communication area of a new access router (AR) 3. The mobile node 1 is communicating with a correspondent node (CN) 4. Furthermore, an old care-of address has been assigned to the mobile node 1 in the communication area of the old access router 2. A description of the steps followed in the sequence chart of FIGS. 1 and 2 is provided below.

(1) The correspondent node 4 transmits a packet to the old care-of address of the mobile node 1. This packet is transferred to the mobile node 1 by the old access router 2.

(2) When the mobile node 1 approaches the communication area of the new access router 3, the old access router 2 predicts the handover of the mobile node 1 and requests the new access router 3 to assign a new care-of address to the mobile node 1.

(3) The new access router 3 generates a new care-of address and notifies the old access router 2 of the new care-of address.

(4) The old access router 2 notifies the mobile node 1 of the received new care-of address.

(5) The mobile node 1 transmits a binding update message to the old access router 2 immediately before switching the radio connection to another radio connection. This binding update message includes an instruction to transfer packets addressed to the old care-of address to the new care-of address.

(6) On receipt of the binding update message, the old access router 2 updates a binding cache according to the message and transmits a response message to the new care-of address. In this way, the new access router 3 receives the response message. Now the updated binding cache at the old access router 2 contains two addresses, namely the old care-of address and the new care-of address.

(7) On receipt of the packet addressed to the old care-of address that has been transmitted from the correspondent node 4, the old access router 2 refers to the binding cache, encapsulates the packet using the new care-of address and forwards the encapsulated packet (tunnelling).

(8) The new access router 3 stores the packet addressed to the new care-of address until a connection is established with the mobile node 1.

(9) The mobile node 1 switches the radio connection. Specifically, the mobile node 1 establishes a radio connection under the new access router 3 and notifies the new access router 3 of the new care-of address.

(10) The new access router 3 transmits a response message to the mobile node 1.

(11) The new access router 3 transmits the packet stored in step (8) to the mobile node 1.

(12) The mobile node 1 transmits a binding update message to the correspondent node 4 (and a home agent, which is not shown in FIG. 1), based on Mobile Ipv6. This binding update message includes an instruction to transfer the packet addressed to a home address to the new care-of address.

(13) After having received the binding update message, the correspondent node 4 transmits the packet to the new care-of address.

As described above, in the fast handover procedure, since the mobile node 1 acquires a new care-of address before the mobile node 1 enters the communication area of a new access router from the communication area of an old access router, delay due to handover decreases.

However, the existing fast handover procedure has the following three problems:

(1) Inefficient routing

(2) Disorder of packet sequence

(3) Packet loss

FIG. 3 shows inefficient routing. In the existing fast handover procedure, as described with reference to FIG. 1, after having received a binding update message from the mobile node 1, the old access router 2 transfers a packet addressed to the mobile node 1 from the correspondent node 4 to the new access router 3. In this case, as shown in FIG. 3, the packet is transferred from the old access router 2 to the new access router 3 through a diverging point router 5. Here, the diverging point router 5 is a router device installed at a node where a route from the correspondent node 4 to the old access router 2 and a route from the correspondent node 4 to the new access router 3 are branched. Since a packet is temporarily transmitted to the old access router 2 and then is transferred to a mobile node at the time of handover, in the existing fast handover procedure, much load is laid upon a network. In particular, too much load is often laid upon a hierarchical network.

FIG. 4 shows the disorder of packet sequence. In this example, it is assumed that packets A, B and C are transmitted from the correspondent node 4 to the mobile node 1 in that order. It is also assumed that immediately after having transmitted packet B, the correspondent node 4 receives a binding update message from the mobile node 1. Specifically, it is assumed that packets A and B are transmitted to an old care-of address and packet C is transmitted to a new care-of address.

In this case, packets A and B are transferred to the new access router 3 through the diverging point router 5 after having been temporarily transmitted to the old access router 2. However, packet C is directly transmitted to the new access router 3. Therefore, sometimes, packet C reaches the mobile node 1 earlier than packets A and B depending on the network configuration. This is called in this specification as “disorder of packet sequence”.

If there is a disorder of a prescribed number (usually three) of packets, a re-transmission process is necessarily performed by transmitting terminal by TCP (RFC2001), and so the transfer rate degrades. In other words, in an environment using TCP, throughput degrades due to the disorder of packet sequence. In the case of applications using UDP/RTP, if there is a disorder of packet sequence, the packets are sometimes discarded. This results in a short break of communication or a dynamic image.

FIG. 5 shows packet loss. FIG. 6 is a sequence chart showing the occurrence of packet loss. In FIGS. 5 and 6, steps 1 through 4 are the same as those described in FIGS. 1 and 2. However, FIGS. 5 and 6 show the operation performed when the old access router 2 could not receive the binding update message transmitted from the mobile node 1 in step (5). Such a situation can occur, for example, when the radio communication environment between mobile node 1 and the access router is very bad or when the mobile node 1 travels at high speed.

(6) The old access router 2 receives the packet addressed to the old care-of address from the correspondent node 4. However, since the old access router 2 does not receive the binding update message from the mobile node 1, it cannot transfer the packet addressed to the old care-of address to the new care-of address. In this case, the mobile node 1 has already entered the communication area of the new access router 3 from the communication area of the old access router 2. Therefore, the received packet is discarded. In other words, there is packet loss.

(7) The mobile node 1 switches the radio connections. Specifically, the mobile node 1 establishes a radio connection under the new access router 3 and notifies the new access router 3 of the new care-of address.

(8) The new access router 3 transmits a response message to the mobile node 1.

(9) The mobile node 1 transmits a binding update message to the old access router 2. This binding update message includes an instruction to transfer the packet addressed to the old care-of address to the new care-of address.

(10) The mobile node 1 transmits the binding update message to the correspondent node 4 and the home agent, based on normal Mobile Ipv6. This binding update message includes an instruction to transfer the packet addressed to the home address to the new care-of address.

(11) The old access router 2 generates a binding cache according to the binding update message received in step (9) and transmits a corresponding message to the mobile node 1.

(12) On receipt of the packet addressed to the old care-of address, the old access router 2 refers to the binding cache generated in step (11) and transfers the packet to the new care-of address.

(13) After having updated the binding cache according to the binding message transmitted in step (10), the correspondent node 4 transmits the packet to the new care-of address.

If there is packet loss as described above, usually, TCP performs a slow-start or re-transmission operation. Therefore, throughput degrades. In the case of a real-time application, there is sometimes a short break of communication or a dynamic image.

Overall then, in the existing fast handover procedure, there is sometimes inefficient routing, a disorder of packet sequence and packet loss.

### SUMMARY OF THE INVENTION

It is an object of the present invention to solve problems in the existing handover procedure. In other words, it is an object of the present invention to prevent inefficient packet transfer occurring at the time of handover. It is another object of the present invention to prevent packet loss or the disorder of packet sequence occurring at the time of handover.

According to the handover method of the present invention, in a case where a mobile node to which the first address is assigned in the communication area of the first router device travels to the communication area of the second router device, while the mobile node is communicating with a correspondent node through the first router device, the second address to be used in the communication area of the second router device is assigned to the mobile node, and a message for transferring packets addressed to the first address to the second address is transmitted to a diverging point router installed in the node where a route from the correspondent node to the first router device and a route from the correspondent node to the second router device are branched.

According to this method, the message for transferring packets is supplied to the diverging point router device at the time of the handover of the mobile node. Therefore, the packet addressed to the first address from the correspondent node is transferred to the second router device by the diverging point router device without being transferred to the first router device. In other words, even at the time of handover, the packet addressed to the mobile node can be transferred through an efficient route.

In the method described above, in a case where the first and second router devices are installed under a gateway, an address of a router installed between the first router device and the gateway and an address of a router installed between the second router device and the gateway are compared, and a router with the same address may be designated as the diverging point router device.

It is important to note that the problem of insufficient routing can be solved by sending a message for transferring packets addressed to the first address to the second address to any router device located in the node where a router from the correspondent node to the first router device and a router from the correspondent node to the second router device overlap. In the extreme cases, the message may be sent to the home agent or the correspondent node. Hence, it is not restricted to the diverging point router but for case of explanation, diverging point router will be used in the rest of the text.

According to the handover method and another aspect of the present invention, in a case where a mobile node to which the first address is assigned in the communication area of the first router device travels to the communication area of the second router device: while the mobile node is communicating with a correspondent node through the first router, the second address to be used in the communication area of the second router device is assigned to the mobile node; packets addressed to the first address are stored in the first router device from when the second address has been assigned to the mobile node until when a message for transferring the packets addressed to the first address to the second address is supplied to the first router device; and when the message is supplied to the first router device through the second router device, the packets stored in the first router device are transferred to the second address.

According to this method, at the time of the handover of the mobile node, the packets addressed to the mobile node are temporarily stored in the first router device. However, after the mobile node has entered the communication area of the second router device from the communication area of the first router device, usually, the message for transferring the packet is directly transmitted from the mobile node to the first router device. However, if the communication environment between the first router device and the mobile node is bad, the message cannot be directly transmitted from the mobile node to the first router device and is instead transmitted to the first router device through the second router device after the mobile node has entered the communication area of the second router device. Therefore, if the first router device has received the message through the second router device, it judges that the mobile node has not received the packets it should receive at the time of handover, and re-transmits the stored packets to the mobile node. In this way, packet loss is avoided.

In addition, before the second router device and the mobile node are connected, the second router device may store packets addressed to the mobile node, read the stored packets in the transmission order of the correspondent node and transmit the packets to the mobile node. According to this method, even when if order of packets addressed to the mobile node is changed at the time of handover, the second router can correctly re-arrange the order.

### BRIEF DESCRIPTION OF THE DRAWINGS

FIG. 1 shows the basic procedure of fast handover;

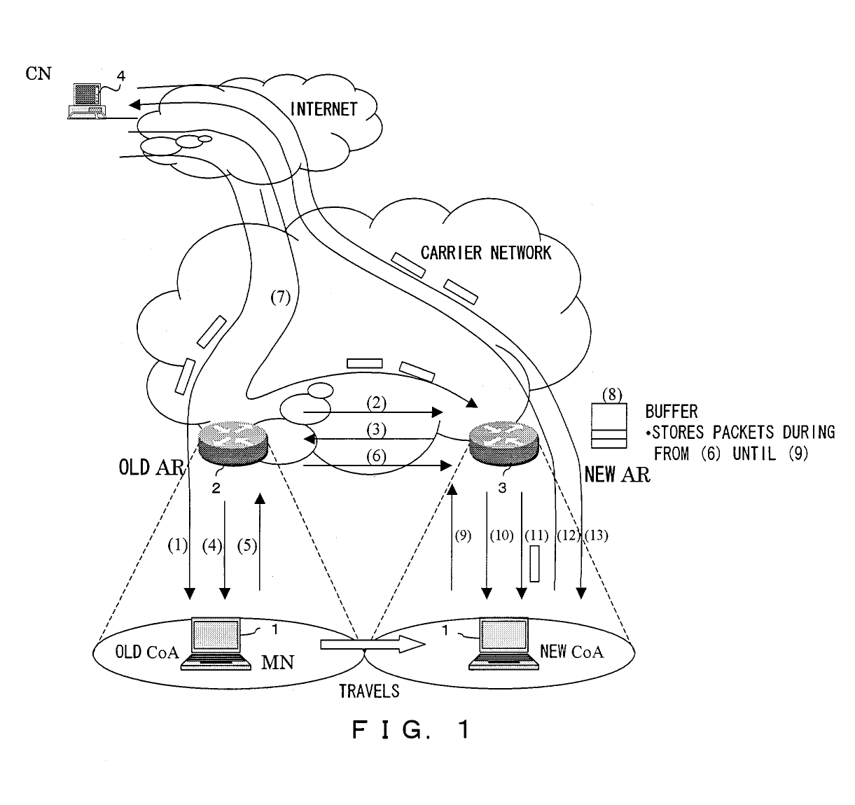

FIG. 2 is a sequence chart showing the process in FIG. 1:

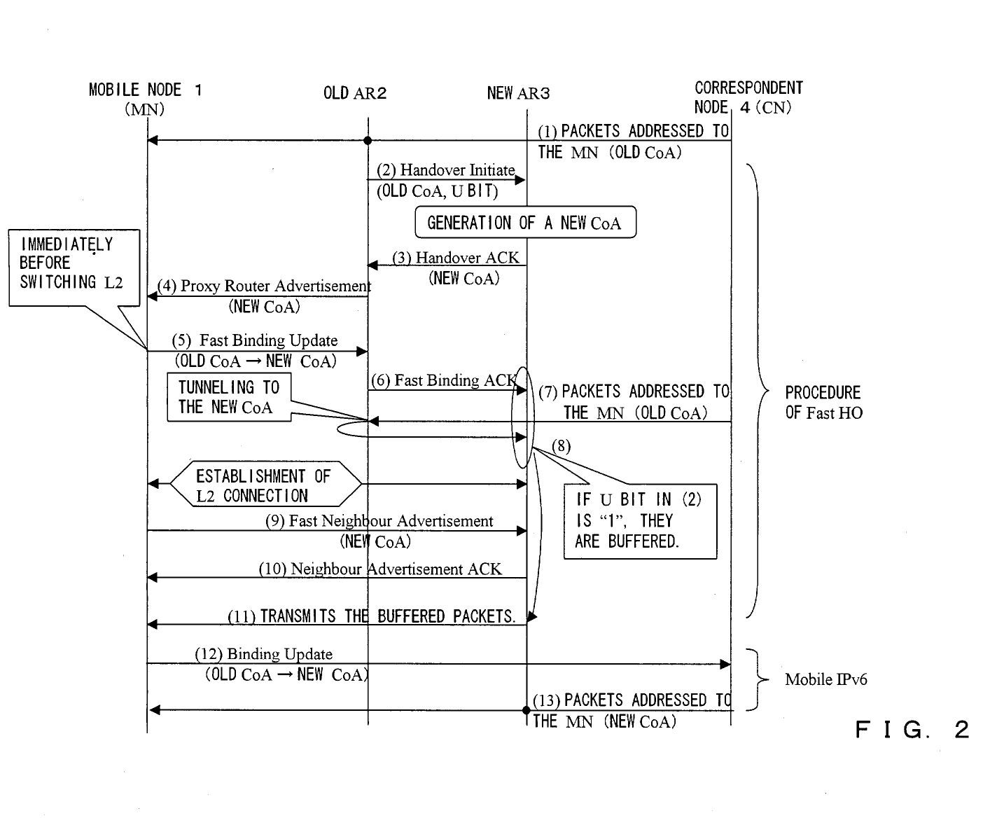

FIG. 3 shows inefficient routing;

FIG. 4 shows the disorder of packet sequence;

FIG. 5 shows packet loss;

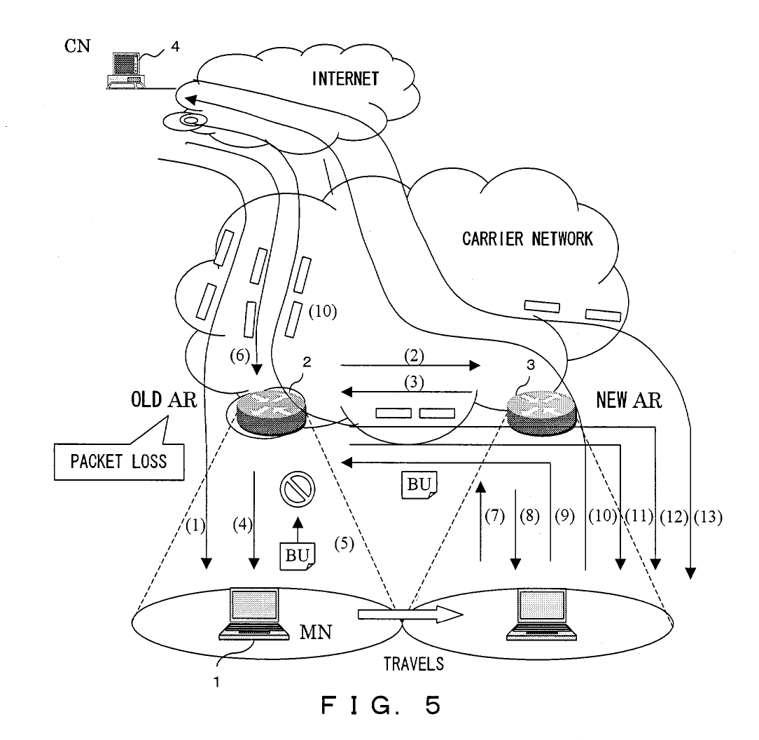

FIG. 6 is a sequence chart showing the case where packet loss occurs;

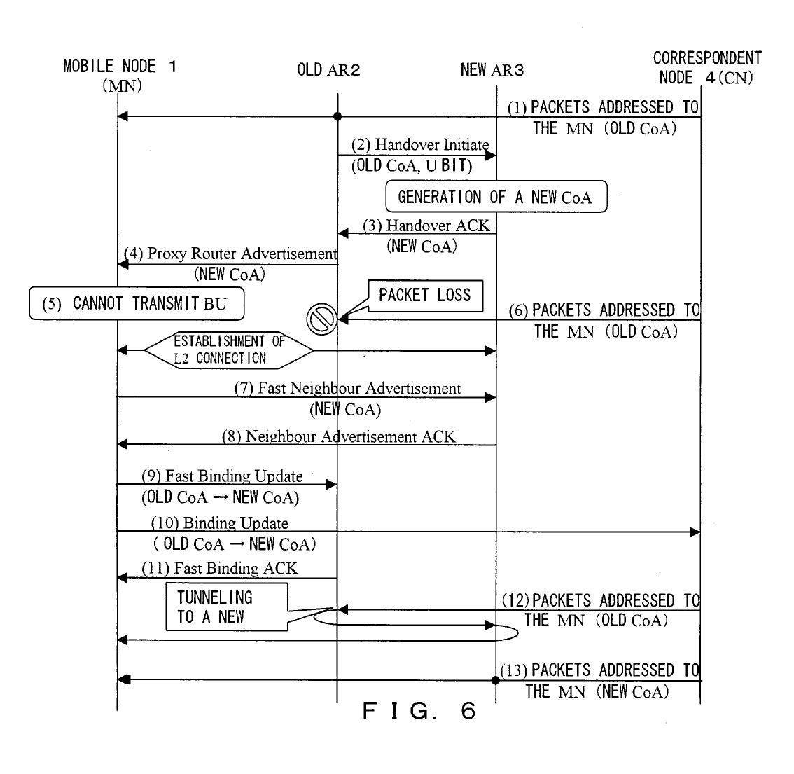

FIG. 7 shows the summary of the present invention;

FIG. 8 shows the handover procedure (at the time of normal operation) in the embodiment of the present invention;

FIG. 9 is a sequence chart corresponding to the operation shown in FIG. 8;

FIG. 10 shows a diverging point router;

FIG. 11 shows the format of a handover initiation message;

FIG. 12 shows the handover procedure (at the time of abnormal operation) in the embodiment of the present invention;

FIG. 13 is a sequence chart corresponding to the operation shown in FIG. 12;

FIG. 14 shows an example of the procedure of avoiding packet loss;

FIG. 15 shows a method for dynamically acquiring the address of a diverging point router;

FIG. 16 is a flowchart showing how to dynamically acquire the address of a diverging point router;

FIG. 17 shows the format of a handover ACK message;

FIG. 18 shows the format of a binding update message;

FIG. 19 is a flowchart showing how to transmit a binding update message to a diverging point router using a MAC address;

FIG. 20 is a flowchart showing how to transmit a binding update message to a diverging point router using a CN address;

FIG. 21 is a flowchart showing the buffering process of an old access router;

FIG. 22 shows the operation of a new access router performed when a packet addressed to a mobile node arrives;

FIG. 23 shows the operation of a new access router performed when the new access router receives a fast neighbor advertisement message from a mobile node;

FIG. 24 shows the handover procedure performed when a diverging point router is located within a MAP area;

FIG. 25 shows the handover procedure performed when a MAP is a diverging point router;

FIG. 26 shows the handover procedure performed when a diverging point router is located out of a MAP area; and

FIG. 27 shows the format of an ICMP message.

### DESCRIPTION OF THE PREFERRED EMBODIMENTS

The embodiments of the present invention are described below with reference to the drawings.

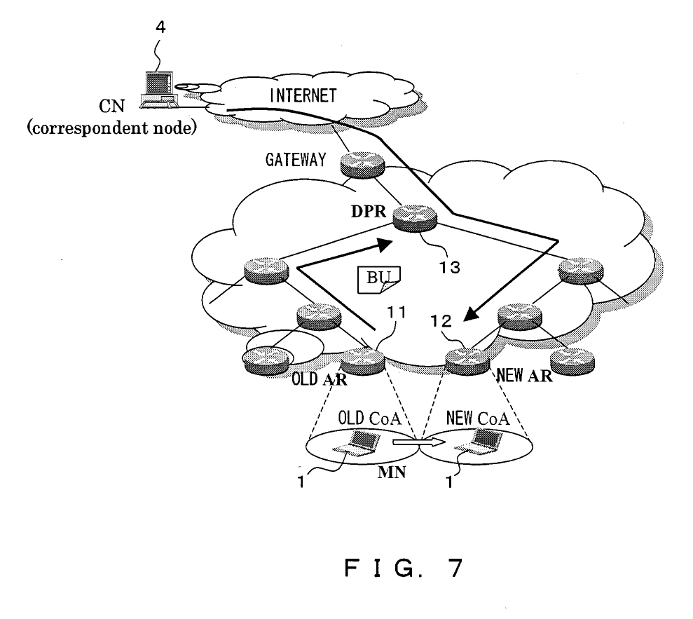

FIG. 7 shows the summary of the present invention. In FIG. 7, it is assumed that a mobile node 1 is communicating with a correspondent node 4. It is also assumed that an old care-of address is assigned to the mobile node 1 in the communication area of an old access router 11. Furthermore, it is assumed that anew care-of address is assigned to the mobile node 1 in the communication area of a new access router 12. Measures taken to solve the three problems that occur in the existing fast handover are described below.

(1) Inefficient Routing

In the handover process of the present invention, when the mobile node 1 travels from the communication area of the old access router (first router device) 11 to the communication area of the new access router (second router device) 12, a binding update message is transmitted from the mobile node 1 to the old access router 11. This binding update message includes an instruction to transfer packets addressed to the old care-of address to the new care-of address. On receipt of the binding update message from the mobile node 1, the old access router 11 transmits the message to a diverging point router 13. The diverging point router 13 is a router device installed in the node where a route from the correspondent node 4 to the old access router 11 and a route from the correspondent node 4 to the new access router 12 are diverged. Alternatively, the diverging point router 13 is a router device installed in the node where a route from a domain gateway to the old access router 12 and a route from the domain gateway to the new access router 12 are diverged.

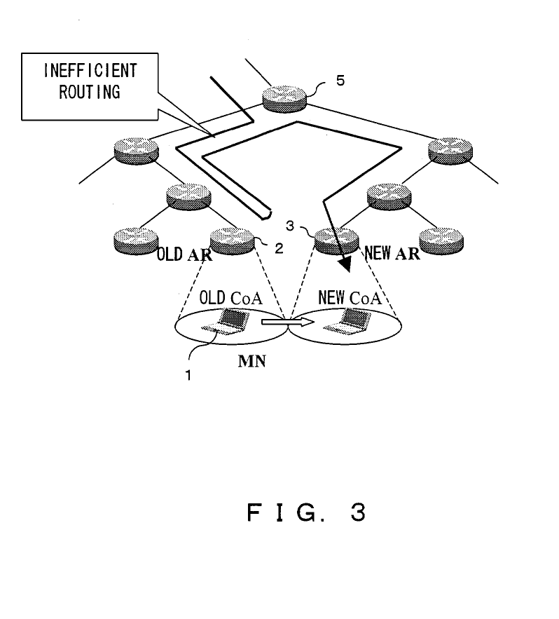

After having received the binding update message, on receipt of a packet addressed to the old care-of address that has been assigned to the mobile node 1, the diverging point router 13 transfers the packet to the new care-of address, newly assigned to the mobile node 1 (tunneling) Therefore, according to the procedures of the present invention, inefficient routing where a packet is temporarily transmitted to the old access router 11 at the time of handover and then is transferred to the mobile node 1 (see FIG. 3) can be avoided.

(2) Disorder of Packet Sequence

The new access router 12 stores packets addressed to the mobile node 1 in a buffer for a specific period at the time of handover of the mobile node 1. When a connection is established between the mobile node 1 and the new access router 12, the new access router 12 transmits the packets stored in the buffer to the mobile node 1. In this case, packet reading from the buffer is appropriately controlled in such a way that the packets can be transmitted to the mobile node 1 in correct order. In this way, the problem of the disorder of packet sequence can be solved.

The packet order can be appropriately re-arranged using an existing buffer management algorithm. Specifically, for example, the order management can be realized using a sequence number set in the TCP header or RTP header of each packet.

(3) Packet Loss

After having notified the mobile node 1 of a new care-of address acquired from the new access router 12, on receipt of packets addressed to the mobile node, the old access router 11 transmits the packets to the mobile node 1, and copies and stores the packets in the buffer. The old access router 11 continues to store the packets until it receives a binding update message from the mobile node 1. In the case of a stateless address configuration, the old access router 11 starts storing packets after having notified the mobile node 1 of the prefix of the new access router 12.

Then, the old access router 11 receives a binding update message from the mobile node 1. In this case, if the old access router 11 receives the binding update message before the access routers are switched over, the old access router 11 judges that the mobile node 1 has received all of the packets stored up to then and discards the packets stored in the buffer. However, if the old access router 11 receives the binding update message after the access routers have been switched over, the old access router 11 transfers all of the packets stored up to then and stops the buffering process.

In this way, if, in the procedures of the present invention, the old access router 11 could not receive a binding update message before the mobile node 1 enters the communication area of the new access router 12, the packets stored in the old access router 11 are re-transmitted to the mobile node 1. Accordingly, the discarding of packets is avoided.

Next, the embodiments of the present invention are described in detail.

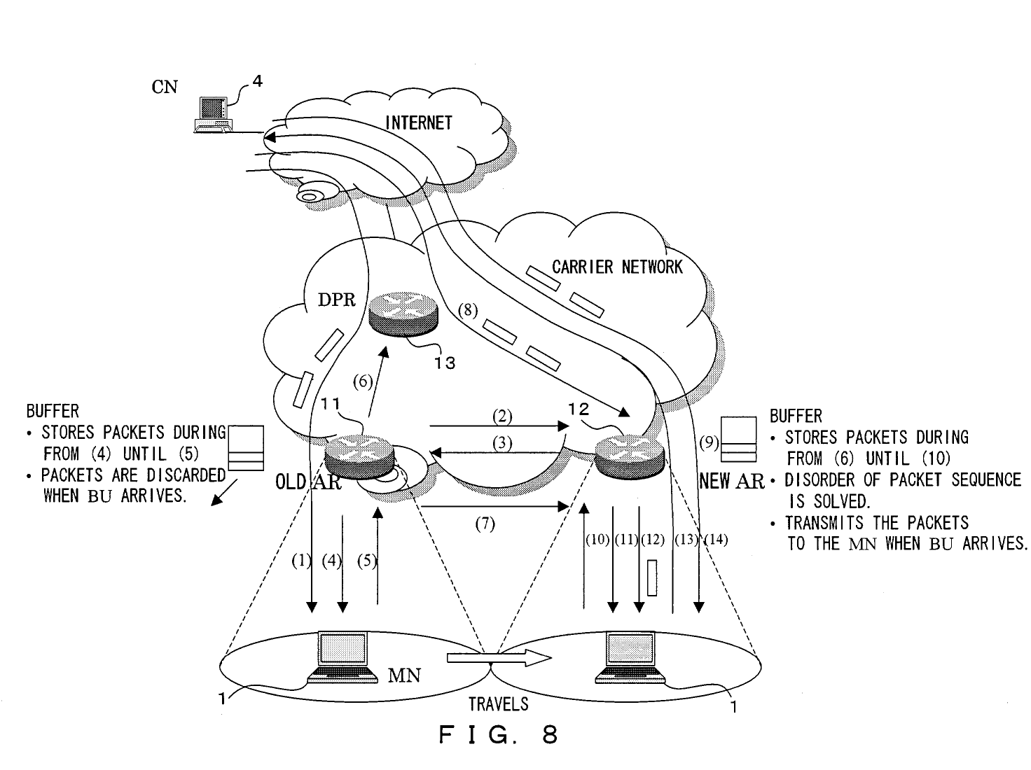

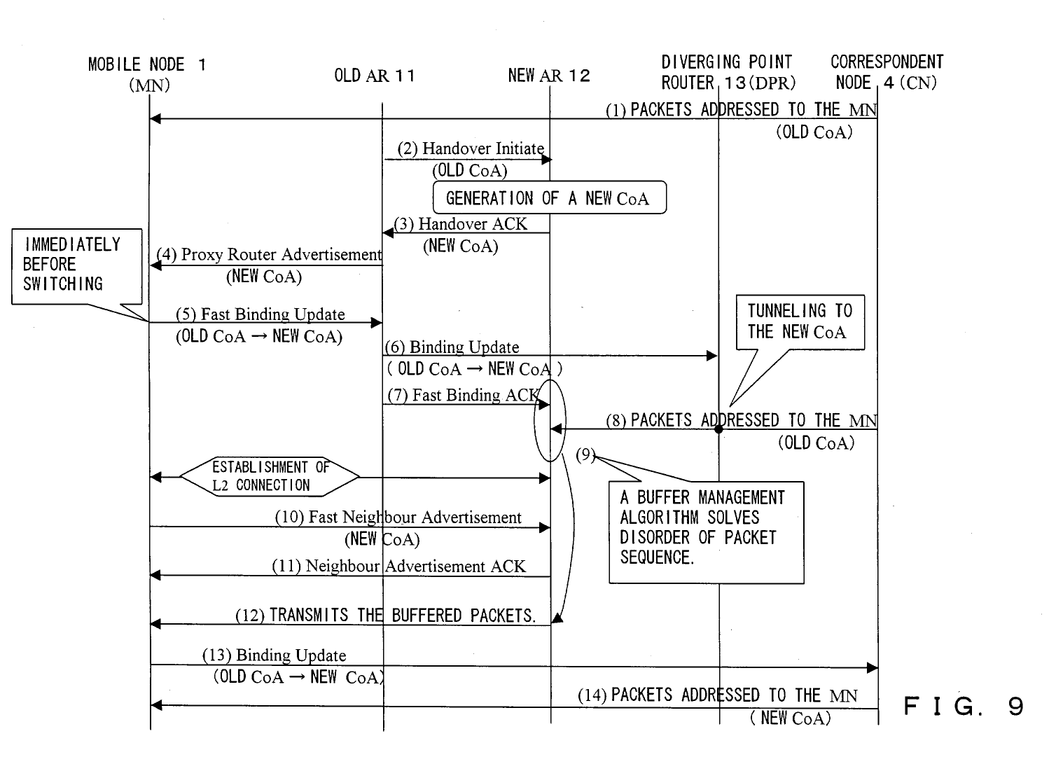

FIG. 8 shows the handover procedure (at the time of normal operation) in the embodiment of the present invention. FIG. 9 is a sequence chart corresponding to the operation shown in FIG. 8.

A mobile node 1, for example, is a portable telephone set and has a function to transmit/receive radio signals with a carrier network. Alternatively, the mobile node 1 need not be limited to a portable telephone set, and it can be another form of terminal set, such as a PDA, a personal computer and the like.

The carrier network comprises a plurality of router devices. In this case, each router device has a function to transfer a packet according to a destination address of the packet. The mobile node 1 is connected to one of the plurality of router devices. A packet transmitted from the mobile node 1 is transferred to the destination address through these router devices. In this case, the router device that processes the packet transmitted from the mobile node 1 in the first place is called an “access router”. The packet addressed to the mobile node 1 is transferred to the access router to which the mobile node 1 is connected and is transmitted from the access router to the mobile node 1.

In this mobile communication network, when the mobile node 1 travels, a corresponding access router is switched. For example, if the mobile node 1 travels from the communication area of the first router device to the communication area of the second router device, an access router corresponding to this mobile node 1 is switched from the first router device (old access router 11) to the second router device (new access router 12).

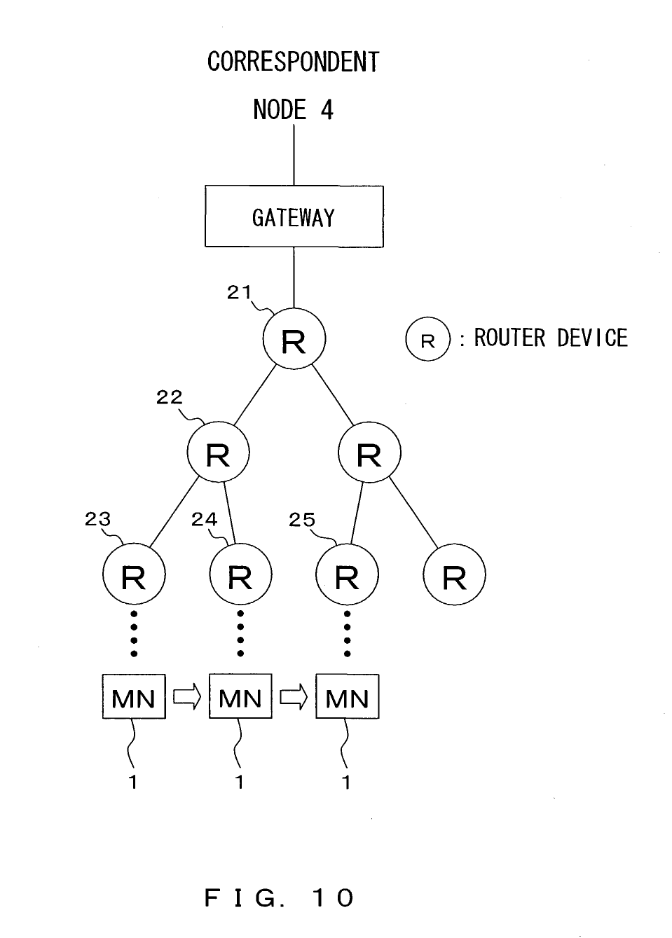

A diverging point router 13 is a router device installed in the node where a route from the correspondent node 4 to the old access router 11 and a route from the correspondent router 4 to the new access router 12 are diverged. For example, in FIG. 10, a case where the mobile node 1 travels from the communication area of a router device 23 to the communication area of a router device 24 is studied. In this case, a route from the correspondent node 4 to the router device 23 and a route from the correspondent node 4 to the router device 24 are diverged in a router device 22. Therefore, the router device 22 is a diverging point router. Similarly, if the mobile node 1 travels from the communication area of the router device 24 to the communication area of the router device 25, a router 21 is a diverging point router.

In this mobile communication network, it is assumed that the mobile node 1 travels from the communication area of the old access router 11 to the communication area of the new access router 12. Specifically, it is assumed that there is handover from the state where the mobile node 1 is connected to the old access router 11 to the state where the mobile node 1 is connected to the new access router 12. It is also assumed that the mobile node 1 is communicating with the correspondent node 4. Furthermore, it is assumed that an old care-of address has been assigned to the mobile node 1 in the communication area of the old access router 11.

The steps of the handover procedure outlined in FIG. 8 are as follows. Note that the following description presumes a stateful address auto-configuration.

(1) The correspondent node 4 is transmitting a packet to the old care-of address of the mobile node 1. This packet is transferred to the old access router 11 and is further transmitted from the old access router 11 to the mobile node 1.

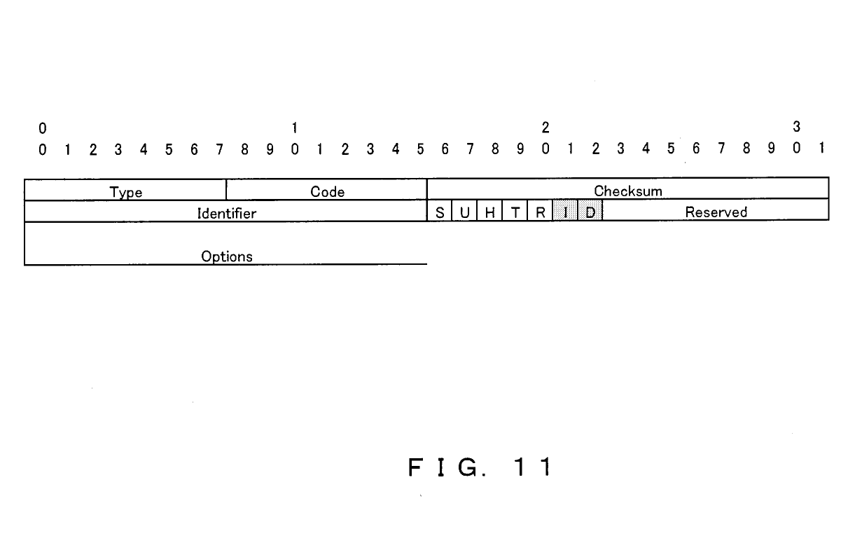

(2) When the mobile node 1 approaches the communication area of the new access router 12, the old access router 11 predicts the handover of the mobile node 1 and transmits a handover initiation message to the new access router 12. This handover initiation message is used to make a request for a new care-of address of the mobile node 1 and has the format shown in FIG. 11.

The format of the handover initiation message is publicly known and comprises a type area, a code area, a checksum area, an identifier area, an S bit, a U bit, an Hbit, a T bit, an Rbit and an options area. However, in the system of this embodiment, an I bit and a D bit are newly defined. In this case, the I bit is used to request a router to correctly re-arrange stored packets according to a buffer management algorithm. The D bit is used to make a request for the IP addresses of router devices located between a new access router and a domain gateway.

In step (2), “1” is set in the U bit of the handover initiate message. In this case, “U bit=1” indicates a request for storing packets. “1” is also set in the I bit. In this case, “I bit=1” indicates a request for resolving a packet order.

(3) The new access router 12 generates anew care-of address of the mobile node 1. In this case, the new access router 12 generates an entry for the new care-of address in a neighbor cache and sets the state of the entry to “IMCOMPLETE”. “IMCOMPLETE” indicates that the mobile node 1 is currently unreachable on the link, which implies that the handover process is unfinished. Then, the new access router 12 notifies the old access router 11 of the new care-of address using a handover acknowledgement message corresponding to the handover initiation message. The neighbor cache is defined in RFC2461.

(4) The old access router 11 notifies the mobile node 1 of the new care-of address using a proxy router acknowledgement message. Here, the old access router 11 initiates a timer for monitoring a failure. When transferring the packet addressed to the old care-of address to the mobile node 1, the old access router 11 starts a process of copying the packet and storing it in the buffer. The buffering process of the old access router 11 is described in detail later.

(5) Immediately before switching the radio connection, the mobile node 1 transmits a fast binding update message to the old access router 11. This binding update message includes an instruction to transfer a packet addressed to the old care-of address to a new care-of address. The source address of this message is the old care-of address of the mobile node 1.

(6) On receipt of the fast binding update message, the old access router 11 updates the binding cache according to the message. In this case, the old access router 11 checks the source address of this message. If the source address is the old care-of address, the old access router 11 judges that it has received the fast binding update message that the mobile node 1 transmitted from the communication area of the old access router 11. In other words, the old access router 11 judges that a normal operation is being performed. In this case, since the old access router 11 receives the fast binding update message transmitted in step (5), it judges that a normal operation is being performed.

In this case, the old access router 11 stops the process of copying the packet, and discards the packets stored in the buffer. In addition, the timer is reset.

Furthermore, the old access router 11 transmits a binding update message to the diverging point router 13. In this case, this binding update message includes an instruction to transfer the packets addressed to the old care-of address to the new care-of address. A process of specifying the diverging point router 13 is described in detail later.

(7) The old access router 11 transmits in return a fast binding acknowledgement message corresponding to the fast binding update message transmitted in step (5). In this way, the new access router 12 receives this fast binding acknowledgement message.

(8) The diverging point router 13 generates a new entry in the binding cache according to the binding update message received in step (6). In this case, information for tunneling packets addressed to the old care-of address of the mobile node 1 to the new care-of address of the mobile node 1 is registered in this entry. Therefore, on receipt of the packets addressed to the old care-of address of the mobile node 1 from the correspondent node 4, the diverging point router 13 tunnels the packets to the new care-of address of the mobile node 1. This means that the packets addressed to the old care-of address are transferred to the new access router 12 without being transferred to the old access router 11.

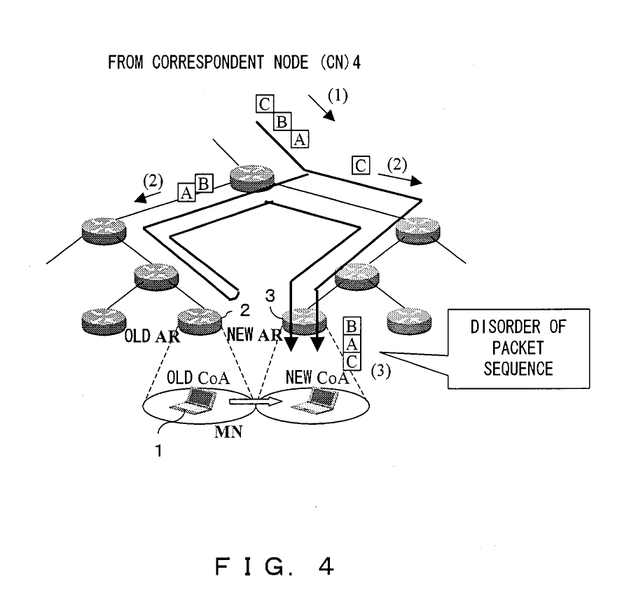

(9) On receipt of packets addressed to the new care-of address, the new access router 12 refers to the neighbor cache and checks the state of the address. In this case, the state of the new care-of address is “IMCOMPLETE”. Therefore, the new access router 12 continues to store packets addressed to the new care-of address. Then, the new access router 12 re-arranges the packets stored in the buffer according to the sequence number written in the TCP header of each packet. Therefore, the problem of the disorder of packet sequence described in FIG. 4 can be avoided. This order control process is performed only when “1” is set in the I bit of the handover initiation message in step (2). This order control process is described in detail later.

(10) When entering the communication area of the new access router 12, the mobile node 1 establishes a radio connection under the new access router 12. Then, the mobile node 1 transmits a fast neighbour advertisement message to the new access router 12 through the radio connection.

(11) The new access router 12 changes the state of the new care-of address registered in the neighbor cache from “IMCOMPLETE” to “REACHABLE”. Then, the new access router 12 transmits, in return, a neighbour advertisement ACK message corresponding to the fast neighbour advertisement message transmitted in step (10), to the mobile node 1.

(12) The new access router 12 transmits the packets stored in the buffer to the new care-of address of the mobile node 1.

(13) The mobile node 1 transmits a binding update message to the correspondent node 4 (and the home agent, which is not shown in FIG. 8), based on Mobile Ipv6. This binding update message includes an instruction to transfer the packets addressed to the home address to a new care-of address.

(14) After having received the binding update message, the correspondent node 4 transmits the packets to the new care-of address.

In this way, in the procedure of the embodiment, the inefficient routing problem described in FIG. 3 can be solved by transmitting a binding update message to the diverging point router 13 in step (6). Since the new access router 12 re-arranges packets, the problem of the disorder of packet sequence described in FIG. 4 can be avoided.

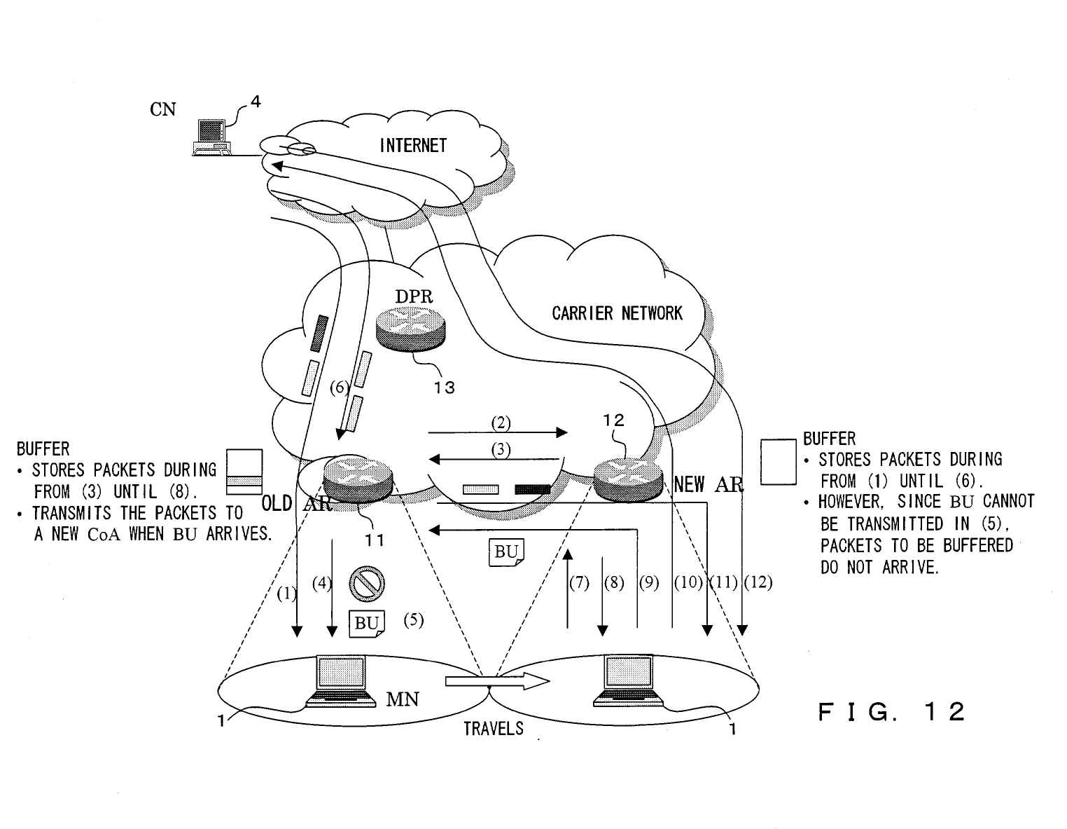

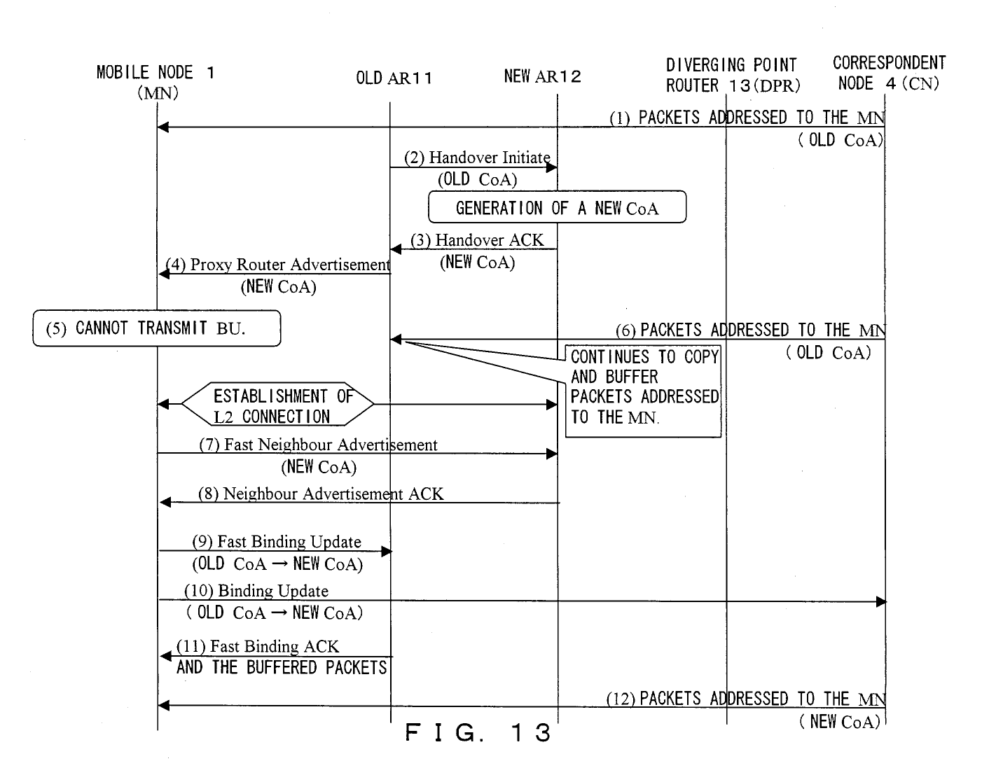

FIG. 12 shows the handover procedure (at the time of abnormal operation) in the embodiment of the present invention. FIG. 13 is a sequence chart corresponding to the operation shown in FIG. 12. In this example, the case where, in step (5) described in FIG. 8, the binding update message transmitted from the mobile node 1 could not reach the old access router 11, for some reason, is assumed. For example, if the radio communication environment between the mobile node 1 and the old access router 11 is very bad or if the mobile node 1 travels in high speed, such a situation can occur.

As described with reference to FIG. 8, in steps (1) through (4), a new care-of address is assigned to the mobile node 1. In addition, the old access router 11 stores packets addressed to the old care-of address of the mobile node 1 in the buffer. Steps (6) and after are described below.

(6) The old access router 11 continues to store packets addressed to the old care-of address of the mobile node 1.

(7) When entering the communication area of the new access router 12, the mobile node 1 establishes a new radio connection under the new access router 12. Then, the mobile node 1 transmits a fast neighbour advertisement message to the new access router 12 through the radio connection. This operation is the same as that of step (10) shown in FIG. 8.

(8) The new access router 12 changes the state of the new care-of address registered in the neighbor cache from “INCOMPLETE” to “REACHABLE”. Then, the new access router 12 transmits a neighbour advertisement ACK message corresponding to the received fast neighbour advertisement message to the mobile node 1. This operation is the same as that of step (11) shown in FIG. 8.

(9) The mobile node 1 transmits a binding update message again to the old access router 11. In this case, this binding update message includes an instruction to transfer packets addressed to the old care-of address to the new care-of address. However, the source address of this message is the new care-of address of the mobile node 1.

(10) The mobile node 1 transmits a binding update message to the correspondent node 4 (and the home agent, which is not shown in FIG. 12), based on Mobile Ipv6. In this case, this binding update message includes an instruction to transfer packets addressed to the home address to the new care-of address. This operation is the same as that of step (12) shown in FIG. 8.

(11) On receipt of the binding update message transmitted from the mobile node 1 in step (9), the old access router 11 updates the binding cache according to the message. At this moment, the old access router 11 checks the transmitter address of this message. In this case, the source address of the message is the new care-of address. Therefore, the old access router 11 judges that it has received the binding update message that the mobile node 1 transmitted from the communication area of the new access router 12. In other words, the old access router 11 judges that an abnormal operation is being performed.

In this case, the old access router 11 tunnels packets addressed to the old care-of address stored in the buffer to the new care-of address, based on Mobile Ipv6. Then, the old access router 11 stops the process of copying the packets and storing them in the buffer, and resets the timer.

(12) After having received the binding update message transmitted in step (10), the correspondent node 4 transmits the packets to the new care-of address.

In this way, in the handover method of the embodiment, when the old access router 11 could not receive the binding update message transmitted in step (5), the packets addressed to the old care-of address of the mobile node 1 are stored in the old access router 11 from when the old access router 11 notifies the mobile node 1 of the new care-of address until when the old access router receives a binding update message through the new access router 12. On receipt of the binding update message through the new access router 12, the old access router 11 transmits the stored packets to the new care-of address of the mobile node 1. Accordingly, packet loss can be avoided.

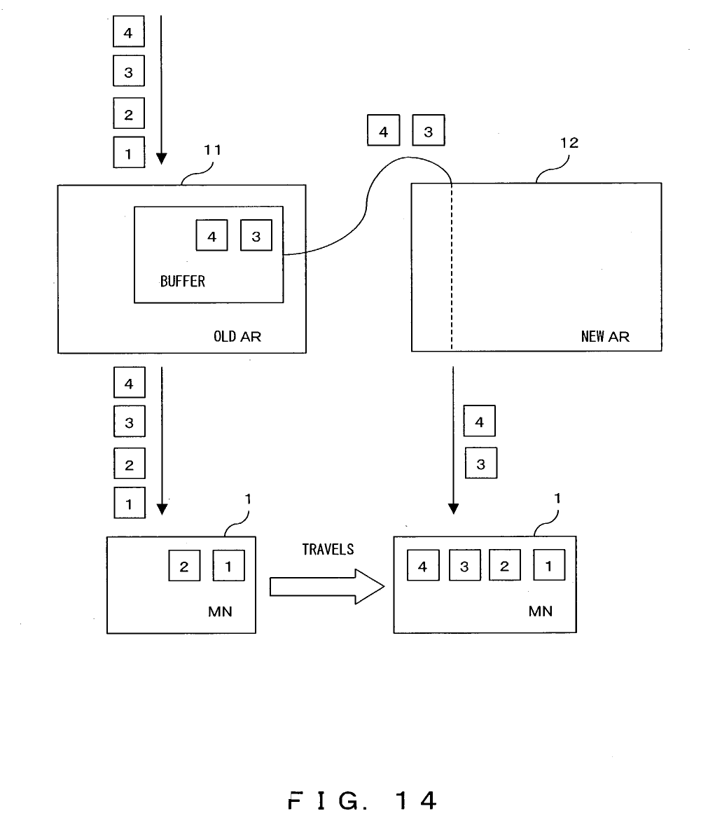

One example is described below. In this example, as shown in FIG. 14, it is assumed that packets 1 through 4 are transmitted to the old care-of address of the mobile node 1. In this case, the old access router 11 transfers these packets to the old care-of address of the mobile node 1. It is also assumed that the old access router 11 notifies the mobile node 1 of the new care-of address after it has transferred packets 1 and 2 to the mobile node 1. In this case, packets 3 and 4 are stored in the buffer of the old access router 11.

In this case, it is assumed that the mobile node 1 enters the communication area of the new access router 12 without receiving packets 3 and 4. It is also assumed that the binding update message transmitted from the mobile node 1 has not directly reached the old access router 11. In this case, on receipt of the binding update message transmitted from the mobile node 1 through the new access router 12, the old access router 11 transmits the packets 3 and 4 stored in the buffer to the new care-of address of the mobile node 1. Then, the mobile node 1 receives packets 3 and 4 through the new access router 12. In this way, the mobile node 1 can receive all of packets 1 through 4. In other words, the occurrence of packet loss can be avoided.

Next, there is a method for the old access router 11 specifying a diverging point router 13 in order to transmit a binding update message. The following four cases are described:

(1) In a case where the address of a diverging point router is defined in advance

(2) In a case where the address of a diverging point router is dynamically acquired

(3) In a case where the address of a diverging point router cannot be acquired (a MAC address is used)

(4) In a case where the address of a diverging point router cannot be acquired (a CN address is used)

(1) In a Case Where the Address of a Diverging Point Router is Defined in Advance

In this case, the geographically adjacent routers (i.e. destination of the mobile node 1) and a diverging point router corresponding to each of these routers are related and registered in each router device. For example, in the router device 24 shown in FIG. 10, “destination: router device 23” and “diverging point router: router device 22” are related and registered, and “Destination: router 25” and “diverging point router: router device 21” are also related and registered. Therefore, for example, if the mobile node 1 travels from the communication area of the router device 24 to the communication area of the router device 23, the router device 22 is specified as a diverging point router. If the mobile node 1 travels from the communication area of the router device 24 to the communication area of the router device 25, the router device 21 is specified as a diverging point router. Then, a binding update message is transmitted to the specified diverging point router. The information indicating the correspondence described above can be, for example, set in each router device when a network is organized.

(2) In a Case Where the Address of a Diverging Point Router is Dynamically Acquired

In this case, it is assumed that each router device knows the address of the domain gateway 20. It is also assumed that each router device knows the IP address of each router device located between the domain gateway 20 and the relevant router device itself. The IP addresses of these router devices can be acquired, for example, through “Trace route”.

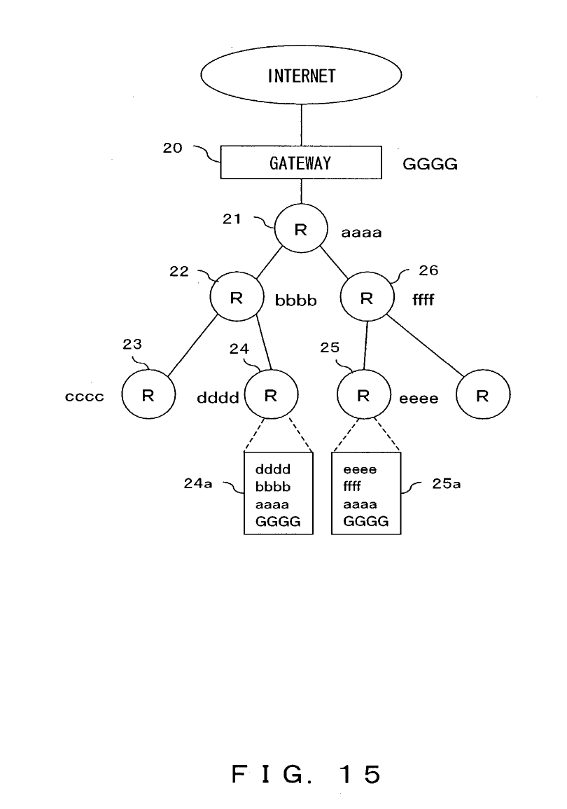

FIG. 15 shows a method for dynamically acquiring the address of a diverging point router. In this example, it is assumed that IP addresses of “aaaa” through “ffff” are assigned to router devices 21 through 26, respectively. It is also assumed that the address of the domain gateway 20 connecting this domain to the Internet is “GGGG”. Each router device manages the addresses of router devices installed between the relevant router device itself and the domain gateway 20. In FIG. 15, the router device 22, the router device 21 and the domain gateway 20 are registered in a router management list 24a provided for the router device 24 in that order. On the other hand, the router device 26, the router device 21 and the domain gateway 20 are registered in a router management list 25a provided for the router device 25 in that order.

If in this mobile communication network, the mobile node 1 travels from the communication area of the router device 24 to the communication area of the router device 25, the router device (old access router) 24 requests the router device (new access router) 25 to transfer the router management list 25a to the router device (old access router) 24. Then, the router device (old access router) 24 compares the router management list 24a with the router management list 25a and detects the identical address. In this example, “aaaa” is registered in both lists. Therefore, in this case, it is judged that the router device 21 is a diverging point router. If there are a plurality of identical addresses in the comparison described above, for example, the closest router device to the old access router is judged to be a diverging point router.

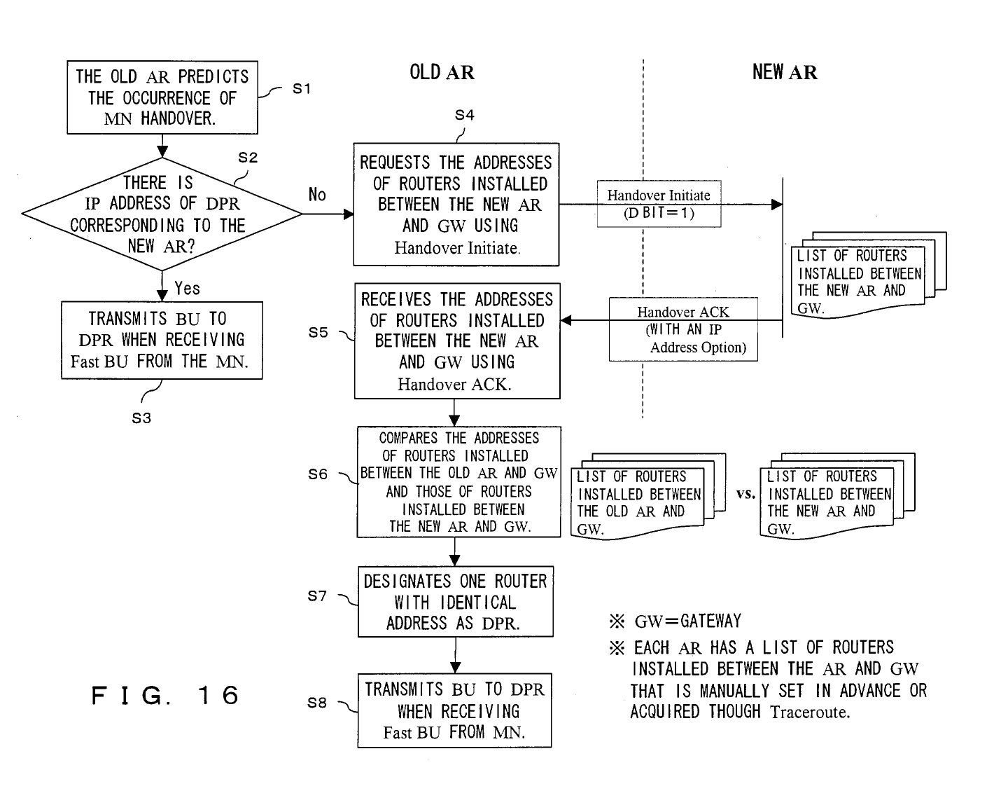

FIG. 16 is a flowchart showing a method for dynamically acquiring the address of a diverging point router. The old access router 11 performs the process of this flowchart.

In step S1, the old access router 11 predicts the occurrence of handover, based on the current location of the mobile node 1 and its travel direction. At this moment, a new access router 12 is specified. A method for predicting a new access router is well known.

In step S2, the old access router checks whether the IP address of a diverging point router, corresponding to the combination of the old access router 11 and the new access router 12 has been already registered in advance or registered before. If the IP address of a diverging point router is already registered, in step S3 the old access router transmits the binding update message received from the mobile node 1 to the diverging point router. If the IP address of a diverging point router is not yet registered, processes in steps 4 and after are performed.

In step S4, the old access router 11 requests the new access router 12 to transmit the address of router devices installed between the new access router 12 and the domain gateway, using a handover initiation message. In this case, “1” is set in the D bit of this handover initiation message, shown in FIG. 11. On receipt of the handover initiation message with “1” set in its D bit, the new access router 12 transmits the router management list 25a shown in FIG. 15 to the old access router 11, using a handover ACK message.

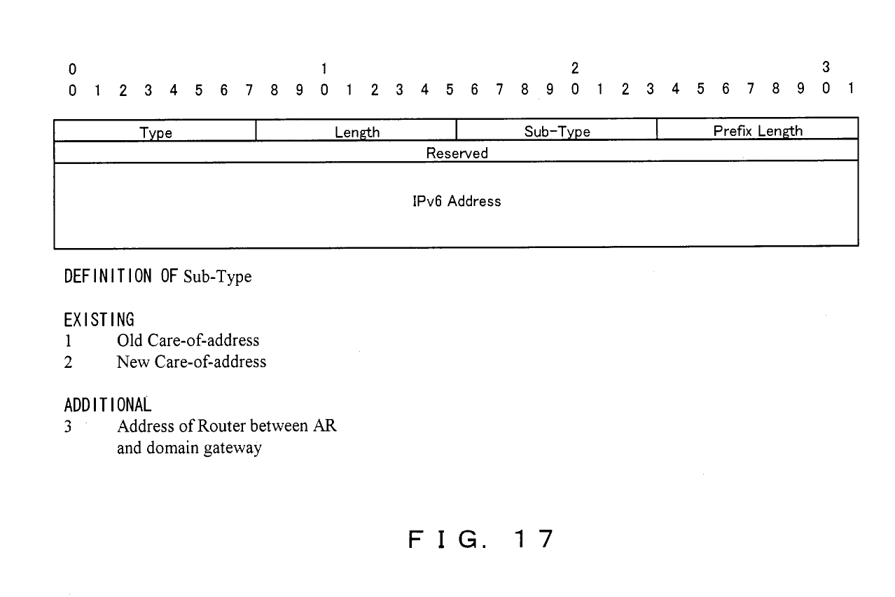

FIG. 17 shows the format of the handover ACK message. This message is used to notify the old access router 11 of addresses. Specifically, if “1” is set as a sub-type, the old care-of address is written in the address area. If “2” is set as a sub-type, a new care-of address is written in the address area. In this embodiment, “3” is newly defined as a sub-type. When the new access router 12 notifies the old access router 11 of one or a plurality of addresses that are stored in the router management list, “3” is set as a sub-type, and the addresses of corresponding router devices are written in the address area.

In step S5, the old access router 11 receives the router management list, in which the addresses of router devices installed between the new access router 12 and the domain gateway are registered, from the new access router 12.

In step S6, the old access router 11 compares the addresses of router devices installed between the old access router 11 and the domain gateway with the addresses of router devices installed between the new access router 12 and the domain gateway. Then, in step S7, the old access router 11 detects a router with identical address. Then, in step S8, the old access router 11 transmits the binding update message received from the mobile node 1, to the router device detected in step S7.

(3) In a Case Where the Address of a Diverging Point Router Cannot Be Acquired (a MAC Address is Used)

In this case, the old access router 11 transmits a binding update message to a diverging point router in hop-by-hop. Specifically, in this case, the old access router 11 hunts for a packet addressed to the mobile node 1 and obtains the source MAC address of the packet. Then, the old access router 11 transmits a binding update message to a neighbour router connected to an interface corresponding to the MAC address. As a method for calculating the IP address of a corresponding neighbour router, based on a source MAC address, for example, a Reverse Address Resolution Protocol (RFC903) is known.

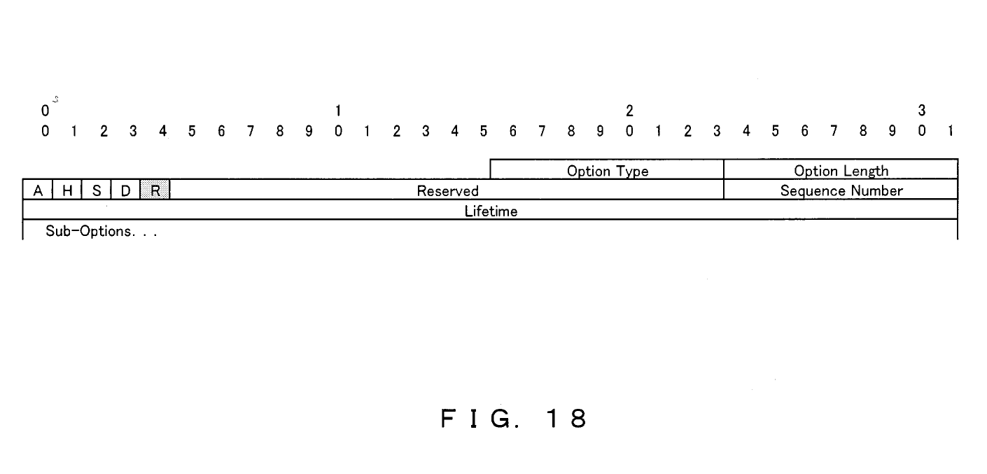

A binding update message used in this embodiment comprises a newly defined R bit, as shown in FIG. 18. R bit is used to request “repetition”. On receipt of a binding update message in which this R bit is set, a router device transfers the message to a next hop router.

By repeating the process described above in each router device, the binding update message is transmitted up to the domain gateway. In other words, the binding cache of each router device installed between the old access router 11 and the domain gateway is updated by the binding update message. Here, a diverging point router must be located between the old access router 11 and the domain gateway. Therefore, the binding cache of a diverging point router is also updated by this procedure.

Although in the example, the source MAC address of a packet addressed to the mobile node 1 is used, a destination MAC address can also be used.

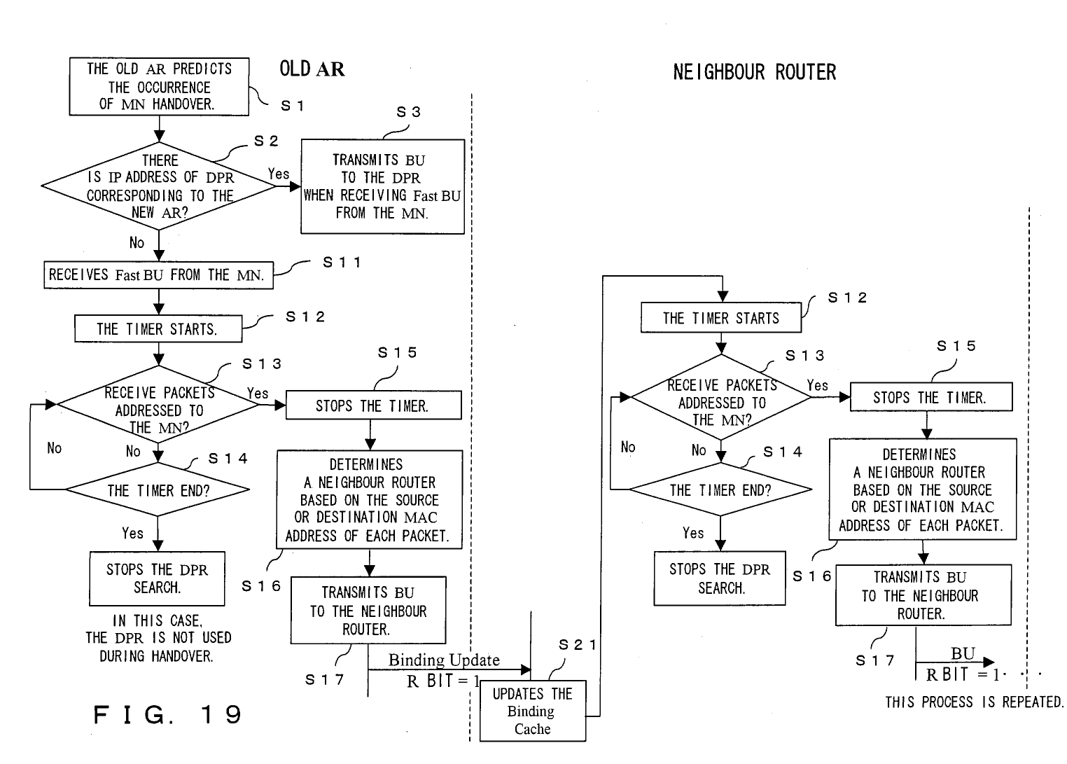

FIG. 19 is a flowchart showing a method for transmitting a binding update message to a diverging point router using a MAC address. Since steps S1 through S3 are the same as those of the method shown in FIG. 16, the descriptions are omitted.

In steps S11 and S12, on receipt of a binding update message from the mobile node 1, the old access router 11 initiates the timer. Then, in steps S13 and S14, the old access router 11 waits for a packet addressed to the mobile node 1. If the old access router receives no packet addressed to the mobile node 1 within a prescribed time period, the old access router stops the process of detecting a diverging point router.

If the old access router 11 receives a packet addressed to the mobile node 1 within a prescribed time period, firstly in step S15, the old access router 11 stops the timer. Then, in step S16, the old access router 11 determines a neighboring router, based on the source or destination MAC address of the received packet. Then, in step S17, the old access router 11 transmits a binding update message to the determined neighboring router. In this case, as described with reference to FIG. 18, “1” is set in the R bit of this binding update message.

On receipt of the binding update message, firstly in step S21, the neighboring router updates the binding cache according to the message. Here, since “1” is set in the R bit, steps S12 through S17 are performed. These processes are the same as those of the old access router 11. Therefore, steps S21 and S12 through S17 are performed in each router device located between the old access router 11 and the domain gateway, and each of the binding caches of these router devices is updated according to the binding update message transmitted from the old access router 11.

(4) In a Case Where the Address of a Diverging Point Router Cannot Be Acquired (a CN Address is Used)

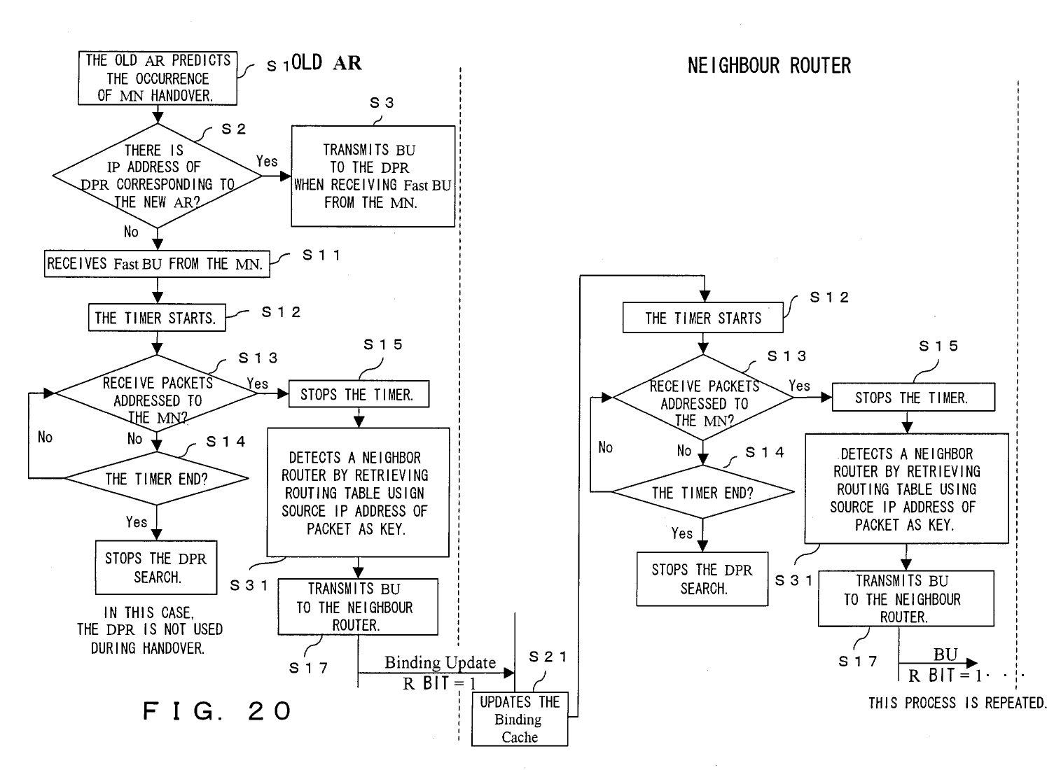

FIG. 20 is a flowchart showing a method for transmitting a binding update message to a diverging point router using a CN address. A method using a CN address (the IP address of the correspondent node 4) is basically the same as that using a MAC address described above. However, according to the method using a CN address, when the old access router 11 hunts for a packet from the correspondent node 4 to the mobile node 1, in step S31 the old access router acquires the source IP address of the packet. Then, the old access router refers to a routing table and detects a next hop corresponding to the source IP address. Then, in step S17, the old access router transmits a binding update message to the next hop.

Next, the process of storing/transferring packets addressed to the old care-of address in the old access router 11 is described. As described above, the old access router 11 temporarily stores packets addressed to the old care-of address at the time of the handover of the mobile node 1, and transfers those packets to the new care-of address of the mobile node 1, as requested.

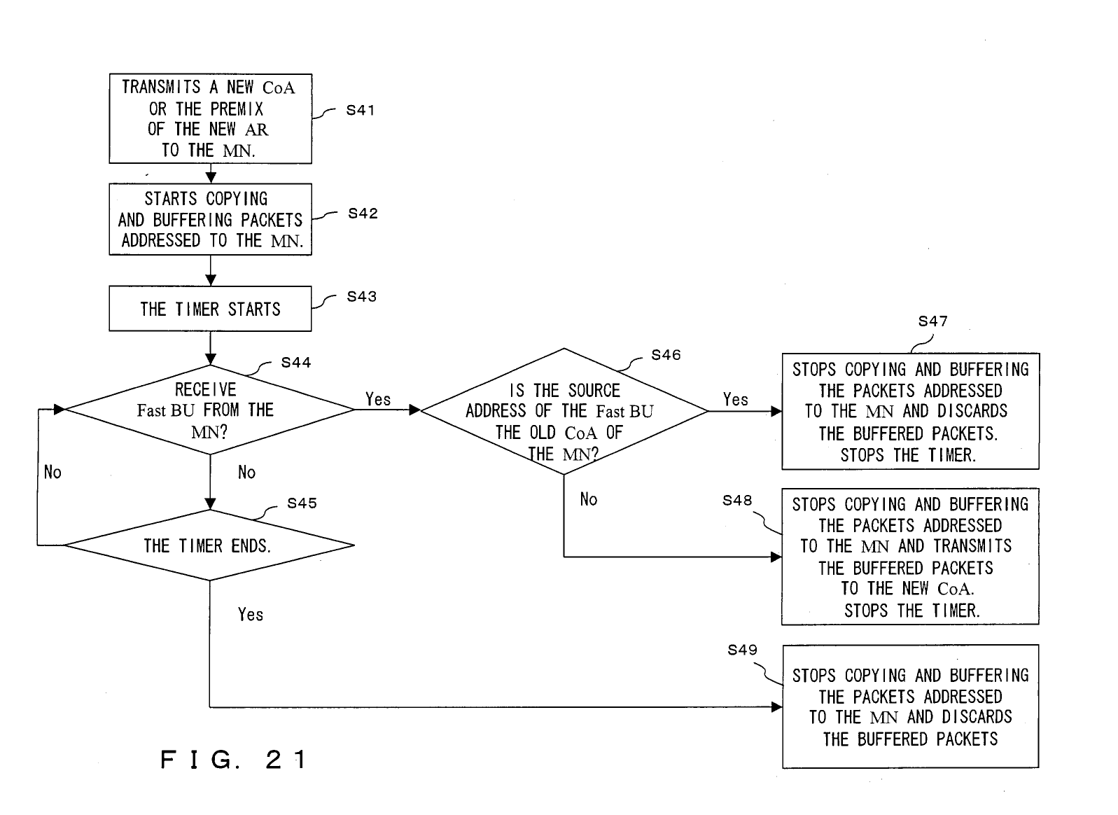

FIG. 21 is a flowchart showing the buffering process of the old access router 11. In this example, a process, after having received the new care-of address of the mobile node 1 from the new access router 12 in step (3) of FIG. 8 or 12, is described.

In step S41, the old access router 11 transmits a received new care-of address or a prefix to the mobile node 1. In steps S42 and 43, the old access router 11 starts copying and buffering packets addressed to the old care-of address of the mobile node 1 and initiates the timer.

In steps S44 and S45, the old access router waits for a binding update message from the mobile node 1 from where the buffering starts until a prescribed time elapses. If the old access router 11 receives a binding update message within the prescribed time period, in step S46 the old access router 11 checks the source address of the message.

If the source address of the binding update message is the old care-of address, the old access router 11 judges that it has received the message transmitted in step (5) of FIG. 8. Then, in step S47, the old access router 11 stops the buffering process and stops the timer. Furthermore, the old access router 11 discards the buffered packets.

If the source address of the binding update message is the new care-of address, the old access router 11 judges that it has received the message transmitted in step (9) of FIG. 12. Then, in step S48, the old access router 11 stops the buffering process and stops the timer. Furthermore, the old access router 11 transmits the buffered packets to the new care-of address.

If the old access router 11 could receive no binding update message from the mobile node 1 within the prescribed time period, in step S49 it stops the buffering process and discards the buffered packets.

If the old access router 11 can specify a packet that the mobile node 1 has received last, it can also start the buffering from the next packet.

Next, a method for controlling the order of packets in the new access router 12 is described.

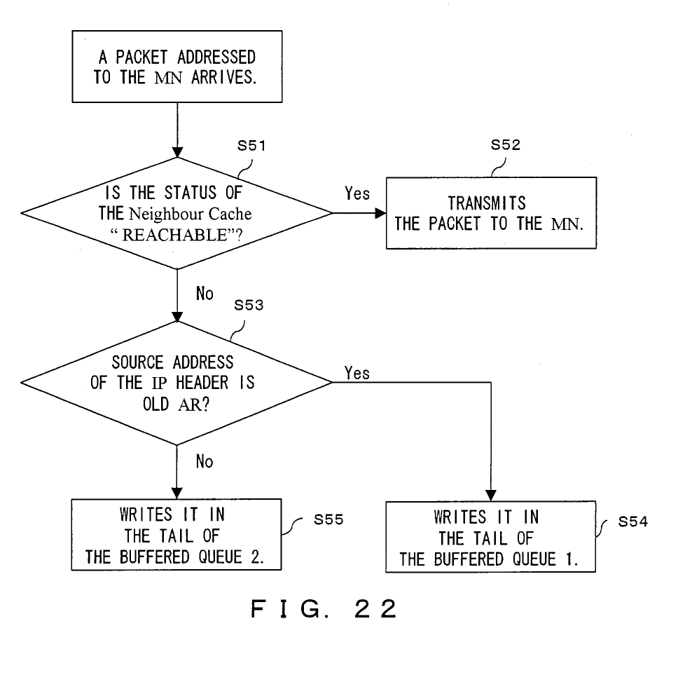

FIG. 22 shows the operation of the new access router 12 performed, when a packet addressed to the mobile node 1 arrives. It is assumed that the destination address of this packet is the new care-of address of the mobile node 1.

In step S51, firstly, the new access router 12 accesses a neighbor cache using the destination address of a received packet (new care-of address of the mobile node 1) as a key and checks the registration status of the address. If “REACHABLE” is registered, in step S52 the new access router 12 transfers the received packet to the mobile node 1 without performing buffering processing. If “INCOMPLETE” is registered, in step S53 the new access router 12 checks the source address set in the IP header of the received packet.

If the source address of the received packet is the old access router 11, in step S54 the new access router 12 writes the packet into the tail-end of the first buffer memory. If the source address of the received packet is not the old access router 11, in step S55 the new access router 12 writes the packet in the tail-end of the second buffer memory. Upon receipt of a packet addressed to the mobile node 1, the new access router 12 writes the packet in a buffer corresponding to the source address of the packet. Processes in steps S53 through S55 correspond to that of step (9) of FIG. 8.

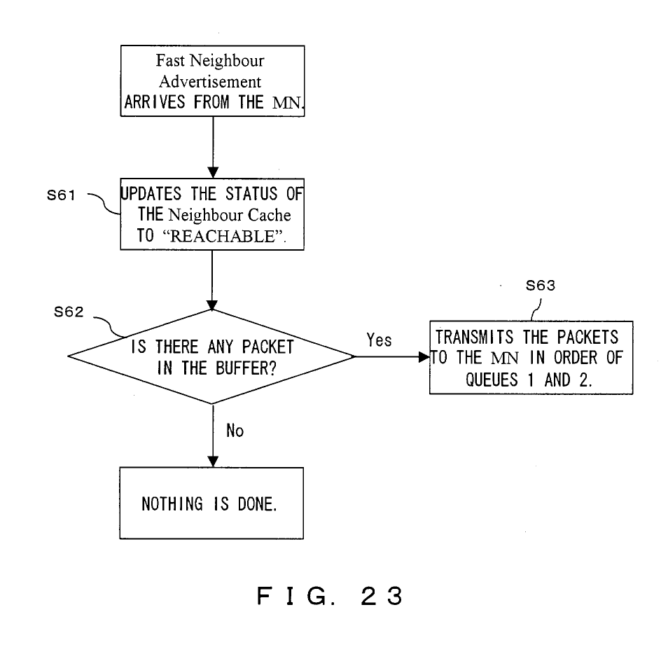

FIG. 23 shows the operation of the new access router 12 performed, when it has received a fast neighbor advertisement message from the mobile node 1.

In step S61, the new access router 12 changes the status of the mobile node 1, registered in a neighbor cache from “IMCOMPLETE” to “REACHABLE”. Then, in step S62, the new access router 12 checks whether the first and second buffer memories store packets addressed to the mobile node 1. If these memories store packets, firstly in step S63 the new access router 12 reads the packet stored in the first buffer memory and then reads the packet stored in the second buffer memory. These read packets are transmitted to the mobile node 1 in read order. If neither of the buffer memories stores a packet, no special operation is performed.

In this way, if the buffer memory stores both packet from the old access router 11 and packets from the correspondent node 4, the new access router 12 transmits the packets from the old access router 11 to the mobile node 1 prior to the packets from the correspondent node 4. In this way, the problem of the disorder of packet sequence can be avoided.

Next, the case where the handover method of this present invention is applied to a hierarchical network using HMIPv6 (hierarchical mobile IPv6) is described. HMIPv6 is described in http://www.ietf.org/internet-drafts/draft-ietf-mobi leip-hmipv6-04.txt.

HMIP (including HMIPv6) hierarchically manages the location of a mobile node using a mobility anchor point (MAP). In this case, a MAP is provided for a foreign domain and manages the movement of a mobile node within its own management area. In HMIPv6 Basic Mode, an address RCOA (regional care-of address) that is fixedly determined within the MAP area and an address LCoA (local care-of address) that varies with each access router located within the MAP area are assigned to each mobile node. Therefore, if a mobile node travels between MAPs, a process for registering a MAP and a process for transmitting a binding update message to a home agent are needed. However, if the mobile node travels within its MAP area, its location registration is completed simply by transmitting a binding update message to the MAP. Note, in general Mobile Ipv6, a binding update message is transmitted to the home agent every time the mobile node travels.

The handover procedure of HMIPv6 is basically the same as that of Mobile Ipv6. However, the handover procedure of HMIPv6 differs from that of Mobile Ipv6 only in that the contents of a binding update message and its destination are different from those of Mobile Ipv6.

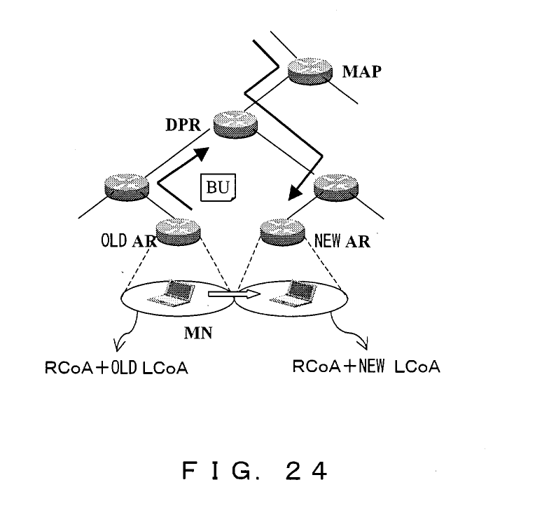

FIG. 24 shows the handover procedure performed when a diverging point router is located within its MAP area. In this case, each of the binding update message transmitted from the mobile node 1 to the old access router 11 in step (5) of FIG. 8 and the binding update message transmitted from the old access router 11 to the diverging point router 13 in step (6) includes an instruction to transfer packets addressed to an old LCOA to a new LCOA. The binding update message transmitted from the mobile node 1 in step (13) of FIG. 8 includes an instruction to transfer packets addressed to an RCoA to a new LCoA, and is transmitted to its MAP. In this case, if the MAP is used as a diverging point router and the route is cut short, an optimal route can be acquired even when step (13) is omitted.

The binding update message transmitted from the mobile node 1 to the old access router 11 in step (9) of FIG. 12 includes an instruction to transfer packets addressed to an old LCoA to a new LCoA. The binding update message transmitted from the mobile node 1 in step (10) of FIG. 12 includes an instruction to transfer packets addressed to an RCOA to a new LCOA, and is transmitted to its MAP.

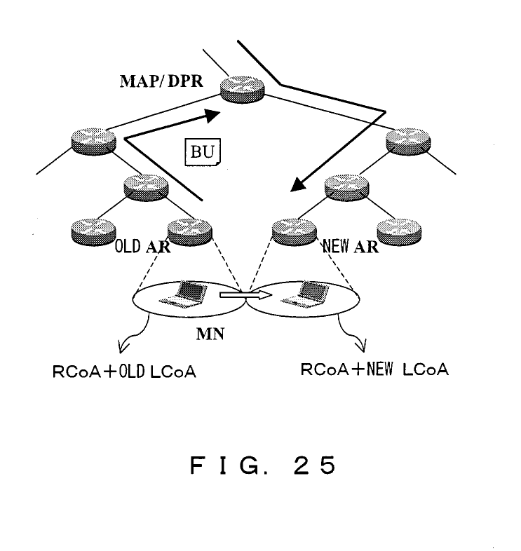

FIG. 25 shows the handover procedure performed when a MAP becomes a diverging point router. In this case, the binding update message transmitted from the mobile node 1 to the old access router 11 in step (5) of FIG. 8 includes an instruction to transfer packets addressed to an old LCOA to a new LCOA. The binding update message transmitted from the old access router 11 to the diverging point router 13 in step (6) includes an instruction to transfer packets addressed to an RCOA to a new LCOA. Since a binding update message is transmitted to its MAP in step (6), steps (13) and (14) shown in FIG. 8 can be omitted.

The binding update message transmitted from the mobile node 1 to the old access router 11 in step (9) of FIG. 12 includes an instruction to transfer packets addressed to an old LCoA to a new LCoA. The binding update message transmitted from the mobile node 1 in step (10) of FIG. 12 includes an instruction to transfer packets addressed to an RCOA to a new LCOA, and is transmitted to its MAP.

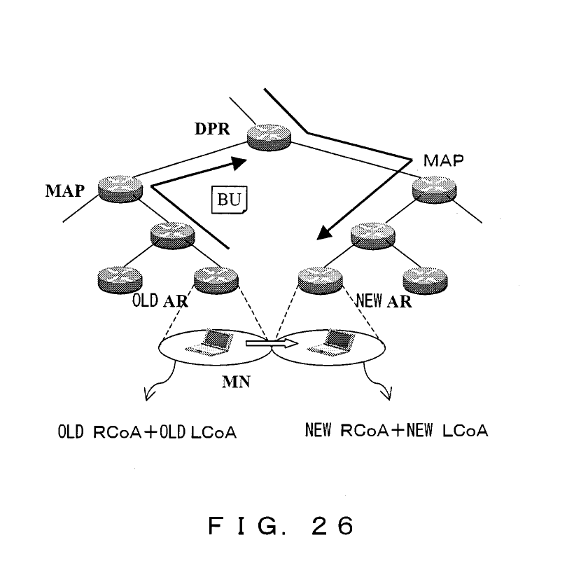

FIG. 26 shows the handover procedure performed when a diverging point router is located outside of the relevant MAP area. In this case, the binding update message transmitted from the mobile node 1 to the old access router 11 in step (5) of FIG. 8 includes an instruction to transfer packets addressed to an old LCOA to a new LCOA. The binding update message transmitted from the old access router 11 to the diverging point router 13 instep (6) includes an instruction to transfer packets addressed to an old RCOA to a new LCOA. Furthermore, the binding update message transmitted from the mobile node 1 in step (13) of FIG. 8 includes an instruction to transfer packets addressed to a new RCoA to a new LCoA, and is transmitted to the MAP.

The binding update message transmitted from the mobile node 1 to the old access router 11 in step (9) of FIG. 12 includes an instruction to transfer packets addressed to an old LCoA to anew LCOA. The binding update message transmitted from the mobile node 1 to the correspondent node 4 and the home agent in step (10) of FIG. 12 includes an instruction to transfer packets addressed to the home address to a new RCoA. However, prior to step (10), the binding update message instructing to transfer packets addressed to a new RCOA to a new LCOA is transmitted to a new MAP by the normal operation of HMIP.

In this way, the handover procedure of the embodiment is applicable to a hierarchical mobile IP network. In other words, the present invention is applicable to Mobile IP, Mobile Ipv6 and hierarchical Mobile Ipv6. Here, a router device can be any one of foreign agent (FA) of Mobile IP, a gateway foreign agent (GFA) and a MAP of hierarchical Mobile Ipv6.

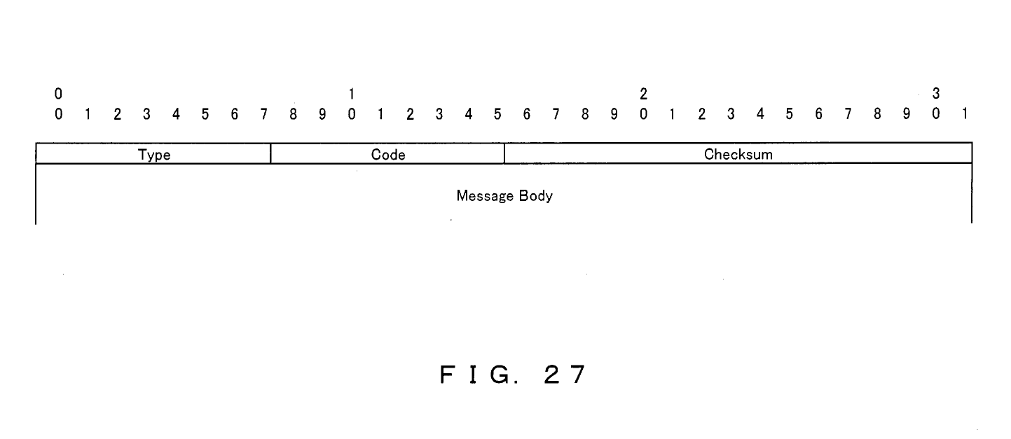

Although in the embodiments described above, the buffering of packets is controlled using a binding update message, an ICMP (Internet control message protocol) can also be used instead of this message. FIG. 27 shows the format of this ICMP message.

According to the present invention, in a mobile communication system, low efficient packet transfer can be avoided at the time of handover. The packet loss and disorder of packet sequence can also be avoided at the time of handover.

What is claimed is:

1. A handover method used when a mobile node to which a first address is assigned in a communication area of a first router device travels from the communication area of the first router device to a communication area of a second router device, comprising:
assigning a second address to be used in the communication area of the second router device to the mobile node, while the mobile node is communicating with a correspondent node through the first router device; and
transmitting a message for transferring a packet addressed to the first address to the second address to a third router device located in a node where the packet route from the correspondent node to the first router device and the packet route from the correspondent node to the second router device overlap.

2. A handover method used when a mobile node to which a first address is assigned in a communication area of a first router device travels from the communication area of the first router device to a communication area of a second router device, comprising:
assigning a second address to be used in the communication area of the second router device to the mobile node, while the mobile node is communicating with a correspondent node through the first router device;
informing the second address to a third router device located in a node where the packet route from the correspondent node to the first router device and the packet route from the correspondent node to the second router device overlap; and
the third router device transferring a packet addressed to the first address to the second address.

3. The method according to claim 1, wherein the first and second router devices are located under a gateway, further comprising:
comparing router devices installed between the first router device and the gateway and router devices installed between the second router device and the gateway to detect an identical router device; and
designating the detected router device as the third router device.

4. The method according to claim 3, wherein
the first router device holds the address of the router devices installed between the first router device and the gateway, and
the first router device obtains the address of the router devices installed between the second router device and the gateway, and compares the address of the router devices installed between the second router device and the gateway with the address of the router devices installed between the first router device and the gateway.

5. The method according to claim 1, wherein
the message is transmitted hop-by-hop to one or more router devices that are determined based on the address of the correspondent node.

6. The method according to claim 5, wherein
a neighboring router to which the message should be transmitted is determined based on a source IP address of the packet transmitted from the correspondent node to the mobile mode.

7. The method according to claim 5, wherein
an IP address of the neighboring router device to which the message should be transmitted is determined based on a source MAC address or a destination MAC address of the packet transmitted from the correspondent node to the mobile node.

8. The method according to claim 1, wherein
the third router device is a home agent of Mobil IP or Mobile IPv6, a gateway foreign agent of hierarchical Mobile IP or a mobility anchor point of hierarchical Mobile IPv6.

9. A handover method used when a mobile node to which a first address is assigned in a communication area of a first router device travels from the communication area of the first router device to a communication area of a second router device, comprising:
assigning a second address to be used in the communication area of the second router device to the mobile node, while the mobile node is communicating with a correspondent node through the first router device;
storing a packet addressed to the first address in the first router device from when the second address is assigned to the mobile node until when a message for transferring the packet addressed to the first address to the second address is supplied to the first router device; and
transmitting the packet stored in the first router device to the second address, when the message is supplied to the first router device through the second router device.

10. A handover method used when a mobile node to which a first address is assigned in a communication area of a first router device travels from the communication area of the first router device to a communication area of a second router device, comprising:
storing a packet addressed to the mobile node in the second router device until the second router device and the mobile node is connected; and
reading the stored packet in a transmitted order by a correspondent node to transmit to the mobile node.

11. The method according to claim 10 wherein
the second router device controls the order of packets using a sequence number of a TCP header or an RTP header.

12. The method according to claim 10, further comprising:
storing a packet from the first router device in a first buffer memory;
storing other packet in a second buffer memory; and
transmitting the packet stored in the first buffer memory to the mobile node and then transmitting the packet stored in the second buffer memory to the mobile node, when the second router device and the mobile node are connected.

13. The method according to claim 1, wherein
the message is a binding update message or an ICMP message.

14. The method according to claim 1, wherein
at least one of the first and second router devices is a mobility anchor point of hierarchical Mobile Ipv6 or a foreign agent of Mobile IP.

15. The method according to claim 1, wherein
the mobile node is a mobile node defined in Mobile IP, Mobile Ipv6 or hierarchical Mobile Ipv6.

16. A router device that is used in a mobile communication system including a plurality of router devices as a first router device among the plurality of router devices, comprising:
predicting means for predicting that a mobile node to which a first address is assigned in a communication area of the first router device travels from the communication area of the first router device to a communication area of a second router device; and
transmitting means for transmitting, when a second address to be used in the communication area of the second router device is assigned to the mobile node according to the prediction, a message for transferring a packet addressed to the first address to the second address to a third router device located in a node where a route from a correspondent node with which the mobile node is communicating to the first router device and a route from the correspondent node to the second router device overlap.

17. A router device that is used in a mobile communication system including a plurality of router devices as a first router device among the plurality of router devices, comprising:
a predicting unit predicting that a mobile node to which a first address is assigned in a communication area of the first router device travels from the communication area of the first router device to a communication area of a second router device; and
a transmitting unit transmitting, when a second address to be used in the communication area of the second router device is assigned to the mobile node according to the prediction, a message for transferring a packet addressed to the first address to the second address to a third router device located in a node where a route from a correspondent node with which the mobile node is communicating to the first router device and a route from the correspondent node to the second router device overlap.
